(19) United States
(12) Patent Application Publication
(10) Pub. No.: US 2026/0350816 A1
(43) Pub. Date: Nov. 5, 2026

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventor: Hiroshi FUKUI, Tokyo (JP)

(73) Assignee: NEC Corporation, Tokyo (JP)

(21) Appl. No.: 19/486,982

(22) PCT Filed: May 29, 2023
(86) PCT No.: PCT/JP2023/019907

§ 371 Date: Nov. 24, 2025

(51) Int. Cl. G06T 7/246

(52) U.S. Cl. CPC G06T 7/248; G06T 2207/10016; G06T 2207/30241

(57) ABSTRACT

An information processing apparatus including: an estimation means for estimating a trajectory of a target appearing in a first frame of a video; an appearance determination means for performing an appearance determination to determine whether or not the target appears in a second frame different from the first frame; and a stay/leave determination means for performing a stay/leave determination to determine whether or not the target appearing in the second frame is on the trajectory.

### TECHNICAL FIELD

This disclosure relates to the technical field of information processing apparatus, information processing methods, and recording medium.

### BACKGROUND ART

Patent Literature 1 uses an action value function in which a “state” including information pertaining to multiple candidate positions of an examination target at a single point in time and an “action” including information on which candidate position the examination target moves to at this single point in time are variables, and determines the “action” of the examination target at the predicted point in time from the “state” at the predicted point in time. The technology for determining the location information of the examination target at the time of prediction and predicting the location information of the examination target at the time of prediction is disclosed.

In Patent Literature 2, the first position information (PIt-τ) concerning the position of an object (Ot-τ) in the first image (IMt-τ) taken at the first time (t-τ) and the position information (PIt-τ) concerning the position of the object (Ot-τ) in the second image (IMt) taken at the second time (t) are determined. The first and second feature vectors (CVt-τ, CVt) are generated based on the first position information (PIt) concerning the position of the object (Ot) in the first image (IMt) taken at the second time (t), and the information obtained by the operation process using the first and second feature vectors is used as the correspondence information (AM) indicating the correspondence between object in the first image and object in the second image. The technology to generate the information obtained by the calculation process using the first and second feature vectors as correspondence information (AM) indicating the correspondence between object in the first image and object in the second image is disclosed.

In Patent Literature 3, a technology is disclosed for tracking an object by extracting, from an image area relating to a single object determined at a time point prior to the single time point, a plurality of image areas in the image at this single time point as a plurality of candidate image areas relating to this single object, and determining, from among the plurality of candidate image areas, an image area relating to this single object that is considered to be correct at this single time point based on evidence including the degree of similarity or overlap between the candidate image area and an image area relating to another object determined at the previous time point or a past image area relating to another object that has been lost, and determining image areas relating to the object or lost object in each image of a time series of images that may include a plurality of objects to be tracked.

In Patent Literature 4, an image feature of an object is outputted using time-series images of the object, an identification result of identifying the object is outputted using the image feature and the tracking result of the object, an appropriate motion model is selected from among multiple motion models based on the identification and tracking results, the object is tracked from the identified target in the time series and the tracking result, the technology for tracking the object in a video image is disclosed.

### CITATION LIST

### Patent Literature

Patent Literature 1: Patent Publication No. 2017-168029

Patent Literature 2: International Publication No. 2021/130951

Patent Literature 3: Patent Publication No. 2018-032078

Patent Literature 4: International Publication No. 2021/181612

### SUMMARY

It is an example target of this disclosure to provide an information processing apparatus, an information processing method, and a recording medium that are intended to improve the techniques/technologies disclosed in Citation List.

### SOLUTION TO PROBLEM

An information processing apparatus according to an example aspect includes: an estimation means for estimating a trajectory of a target appearing in a first frame of a video; an appearance determination means for performing an appearance determination to determine whether or not the target appears in a second frame different from the first frame; and a stay/leave determination means for performing a stay/leave determination to determine whether or not the target appearing in the second frame is on the trajectory.

An information processing method according to an example aspect includes: estimating a trajectory of a target appearing in a first frame of a video; performing an appearance determination to determine whether or not the target appears in a second frame different from the first frame; and performing a stay/leave determination to determine whether or not the target appearing in the second frame is on the trajectory.

A recording medium according to an example aspect is a recording medium on which a computer program that allows a computer to execute an information processing method is recorded, the information processing method including: estimating a trajectory of a target appearing in a first frame of a video; performing an appearance determination to determine whether or not the target appears in a second frame different from the first frame; and performing a stay/leave determination to determine whether or not the target appearing in the second frame is on the trajectory.

### BRIEF DESCRIPTION OF DRAWINGS

FIG. 1 shows a block diagram of the configuration of the information processing apparatus according to the first example embodiment.

FIG. 2 shows a block diagram of the configuration of the information processing apparatus according to the second example embodiment.

FIG. 3 shows a conceptual diagram of the information processing operation of the information processing apparatus according to the second example embodiment.

FIG. 4 shows a flowchart of the tracking operation of the information processing apparatus according to the second example embodiment.

FIG. 5 shows a conceptual diagram of the information processing behavior of the information processing apparatus according to the second example embodiment.

FIG. 6 shows a conceptual diagram of the information processing operation of the information processing apparatus according to the second example embodiment.

FIG. 7 shows a conceptual diagram of the information processing behavior of the information processing apparatus according to the second example embodiment.

FIG. 8 shows a block diagram of the configuration of the information processing apparatus according to the third example embodiment.

FIG. 9 shows a flowchart of the tracking operation of the information processing apparatus according to the third example embodiment.

FIG. 10 is a conceptual diagram of the information processing operation of the information processing apparatus according to the third example embodiment.

FIG. 11 shows a block diagram of a tracking network.

FIG. 12 shows a conceptual diagram of the operation of the tracking network.

### DESCRIPTION OF EXAMPLE EMBODIMENTS

The following is a description of the example embodiments of the information processing apparatus, information processing method, and recording medium, with reference to the drawings.

### 1: First Example Embodiment

The first example embodiment of the information processing apparatus, information processing method, and recording medium will be described. In the following, the first example embodiment of the information processing apparatus, information processing method, and recording medium will be described using information processing apparatus 1 to which the first example embodiment of the information processing apparatus, information processing method, and recording medium is applied.

### [1-1: Configuration of Information Processing Apparatus 1]

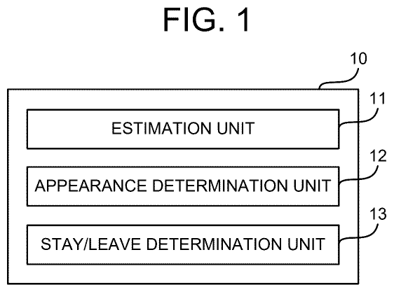

FIG. 1 is a block diagram showing the configuration of the information processing apparatus 1 according to the first example embodiment. As shown in FIG. 1, the information processing apparatus 1 is equipped with an estimation unit 11, an appearance determination unit 12, and a stay/leave determination unit 13. The estimation unit 11 estimates a trajectory of a target appearing in a first frame of a video. The appearance determination unit 12 determines whether the target appears in a second frame that differs from the first frame. The determination of whether or not the target appears in the second frame different from the first frame is referred to as the appearance determination. The stay/leave determination unit 13 determines whether the target appearing in the second frame is on the trajectory estimated or not. The determination as to whether or not the target appearing in the second frame is on the trajectory estimated is referred to as the stay/leave determination.

### [1-2: Technical Effect of the Information Processing Apparatus 1]

The information processing apparatus 1 according to the first example embodiment performs the estimation of the trajectory of the target, the appearance determination, and the stay/leave determination, so that the transition of the position of the target appearing in the frames of the video can be accurately acquired.

### 2: Second Example Embodiment

The second example embodiment of the information processing apparatus, information processing method, and recording medium will now be described. In the following, the second example embodiment of the information processing apparatus, information processing method, and recording medium will be explained using information processing apparatus 2 to which the second example embodiment of the information processing apparatus, information processing method, and recording medium is applied.

### [2-1: Configuration of Information Processing Apparatus 2]

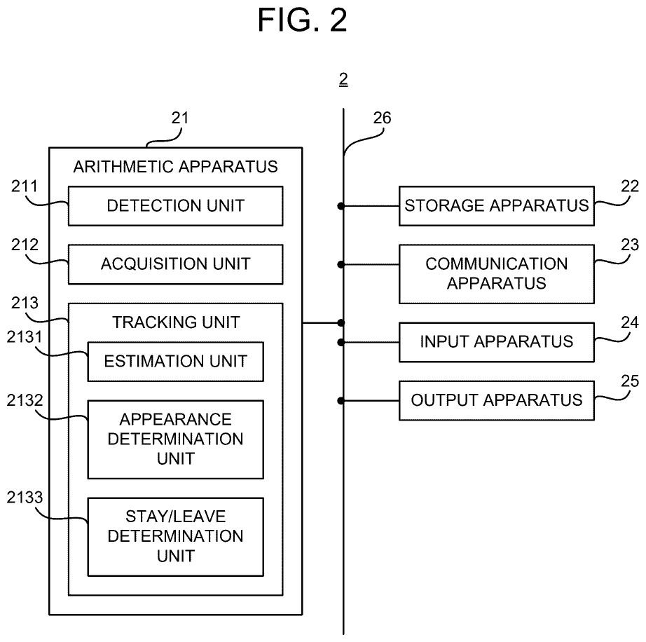

FIG. 2 is a block diagram showing the configuration of information processing apparatus 2 in the second example embodiment. As shown in FIG. 2, the information processing apparatus 2 is equipped with an arithmetic apparatus 21 and a storage apparatus 22. Furthermore, the information processing apparatus 2 may be equipped with a communication apparatus 23, an input apparatus 24, and an output apparatus 25. However, the information processing apparatus 2 may not be equipped with at least one of the communication apparatus 23, the input apparatus 24, and the output apparatus 25. The arithmetic apparatus 21, the storage apparatus 22, the communication apparatus 23, the input apparatus 24, and the output apparatus 25 may be connected via a data bus 26.

The arithmetic apparatus 21 includes, for example, at least one of a CPU (Central Processing Unit), a GPU (Graphics Processing Unit), and an FPGA (Field Programmable Gate Array). The arithmetic apparatus 21 reads a computer program. For example, the arithmetic apparatus 21 may read a computer program stored by the storage apparatus 22. For example, the arithmetic apparatus 21 may read a computer program stored by a computer-readable and non-transitory recording medium using a recording medium reading apparatus (e.g., the input apparatus 24 described below) not shown in the FIG. provided by the information processing apparatus 2. The arithmetic apparatus 21 may obtain (i.e., download or read) the computer program from an unshown apparatus located outside the information processing apparatus 2 via the communication apparatus 23 (or other communication apparatus). The arithmetic apparatus 21 executes the loaded computer program. As a result, logical functional blocks for executing operations to be performed by the information processing apparatus 2 are realized in the arithmetic apparatus 21. In other words, the arithmetic apparatus 21 can function as a controller to realize logical functional blocks for executing operations (in other words, processing) to be performed by the information processing apparatus 2.

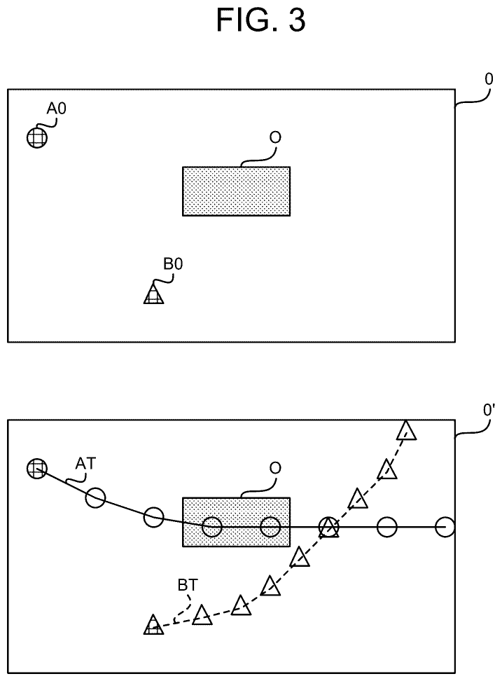

FIG. 2 shows an example of a logical functional block realized in the arithmetic apparatus 21 for executing information processing operations. As shown in FIG. 3, a detection unit 211, which is a specific example of a “detection means” described in the Supplementary Note below, an acquisition unit 212, and a tracking unit 213, which is a specific example of a “tracking means” described in the Supplementary Note below, are realized within the arithmetic apparatus 21. However, the acquisition unit 212 may not be realized within the arithmetic apparatus 21. The tracking unit 213 includes a trajectory estimation unit 2131, which is one specific example of “estimation means” described in the Supplementary Note below, an appearance determination unit 2132, which is one specific example of “appearance determination means” described in the Supplementary Note below, and a stay/leave determination unit 2133, which is one specific example of “stay/leave determination means” described in the Supplementary Note below. Details of the respective operations of the detection unit 211, the acquisition unit 212, and the tracking unit 213 will be described later with reference to FIG. 3 through FIG. 7.

The storage apparatus 22 can store desired data. For example, the storage apparatus 22 may temporarily store a computer program to be executed by the arithmetic apparatus 21. The storage apparatus 22 may temporarily store data that is temporarily used by the arithmetic apparatus 21 in case where the arithmetic apparatus 21 is executing the computer program. The storage apparatus 22 may store data for long-term storage by the information processing apparatus 2. The storage apparatus 22 may include at least one of RAM (Random Access Memory), ROM (Read Only Memory), hard disk apparatus, magneto-optical disk apparatus, SSD (Solid State Drive), and disk array apparatus. In other words, the storage apparatus 22 may include a non-temporary storage medium.

The communication apparatus 23 is capable of communicating with apparatus external to the information processing apparatus 2 via an unshown communication network. The communication apparatus 23 may be a communication interface based on standards such as Ethernet (registered trademark), Wi-Fi (registered trademark), Bluetooth (registered trademark), USB (Universal Serial Bus), etc.

The input apparatus 24 is an apparatus that accepts input of information to the information processing apparatus 2 from outside the information processing apparatus 2. For example, the input apparatus 24 may include a control apparatus (e.g., at least one of a keyboard, a mouse, and a touch panel) that can be operated by an operator of the information processing apparatus 2. For example, the input apparatus 24 may include a reading apparatus capable of reading information recorded as data on a recording medium that can be externally attached to the information processing apparatus 2.

The output apparatus 25 is an apparatus that outputs information to the outside of the information processing apparatus 2. For example, the output apparatus 25 may output information as an image. That is, output apparatus 25 may include a display apparatus (so-called display) capable of displaying an image showing the information to be output. For example, output apparatus 25 may output information as sound. That is, output apparatus 25 may include a sound apparatus (so-called speaker) capable of outputting sound. For example, output apparatus 25 may output information on paper. In other words, the output apparatus 25 may include a printing apparatus (so-called printer) capable of printing desired information on paper.

### [2-2: Information Processing Operations Performed by Information Processing Apparatus 2]

With reference to FIG. 3 through FIG. 7, the information processing operations performed by the information processing apparatus 2 will be described. In this example embodiment, the case in which a person is the target and the person is tracked is described. In this example embodiment, a video shot by a camera with a fixed angle of view and each frame containing the same space will be used as an example.

### [2-2-1: Detection Operation]

FIG. 3 is a conceptual diagram of the detection operation performed by the information processing apparatus 2. FIG. 3 illustrates a frame of a video. The frame illustrated by FIG. 3 is a specific example of a “first frame” as described in the Supplementary Note below. The frame illustrated by FIG. 3 is referred to as frame 0. FIG. 3 illustrates a case in which the two persons to be tracked first appear in the video at frame 0. In other words, the detection unit 211 detects the two persons to be tracked from frame 0. The detection unit 211 may identify the two detected persons as person A and person B.

The circle AO of the lattice pattern in frame 0 of FIG. 3 exemplifies the position of person A in frame 0 (the position in the “first frame” is called the “initial position”), and the triangle B0 of the lattice pattern exemplifies the initial position of person B in frame 0. The frame illustrated by the frame 0 of FIG. 3 includes an occlusion region O. The occlusion region O is, for example, a region in the space included in the frame that is closer to the camera than the person to be tracked and contains an object that hides the person to be tracked from the frame. Thus, in case where the person to be tracked is in occlusion region O in the frame, the person to be tracked will not appear in the frame. For example, the occlusion region O may be a region in which a structure fixed in space is captured. The occlusion region O may also be a region in which a person other than the tracked person of interest appears. The information about the occlusion region O may be known or may be inferred from other frames.

In case where the detection unit 211 detects a person to be tracked, the trajectory estimation unit 2131 estimates the trajectory of the person to be tracked. The trajectory estimation unit 2131 may estimate the future trajectory of the person to be tracked. The trajectory estimation unit 2131 may estimate the trajectory using only a single frame. The trajectory estimation unit 2131 may also estimate the trajectory using two or more frames. In other words, there is no specification for the number of frames required for the trajectory estimation unit 2131 to estimate the trajectory. The future trajectory includes the position of the person to be tracked in a later frame than the corresponding frame (i.e., a frame taken after the corresponding frame). The later frame is an example of a “second frame” as described in the Supplementary Note below. The trajectory estimation unit 2131 may be rephrased as estimating the transition of the position of the person to be tracked in the later frame. The detection unit 2131 may also be rephrased as detecting the target whose trajectory is estimated by the trajectory estimation unit 2131. The trajectory estimation unit 2131 may estimate the trajectory from the frame to the exit of the person to be tracked.

For example, the trajectory estimation unit 2131 may estimate the trajectory using a module that handles time series. For example, the trajectory estimation unit 2131 may estimate the trajectory using a recurrent neural network (RNN) that employs Long Short Term Memory (LSTM). Alternatively, the trajectory estimation unit 2131 may estimate the trajectory using a model that generates the trajectory by a mechanism different from the RNN. Or, the trajectory estimation unit 2131 may estimate the trajectory based on predefined rules using the acceleration of the target's movement in the video. In the second example embodiment, the trajectory estimation unit 2131 may perform estimation using any estimation method.

A frame 0′ of FIG. 3 shows the trajectory AT of person A estimated by the trajectory estimation unit 2131 and the trajectory BT of person B estimated by the trajectory estimation unit 2131. The white circle in the frame 0′ of FIG. 3 illustrates the position of person A in the trajectory estimation in the later frames of the frame 0′ of FIG. 3 illustrates that person A is hidden in occlusion region O in the later frames. The white triangle in the frame 0′ of FIG. 3 illustrates the estimated position of person B in the later frames.

### [2-2-2: Tracking Operation]

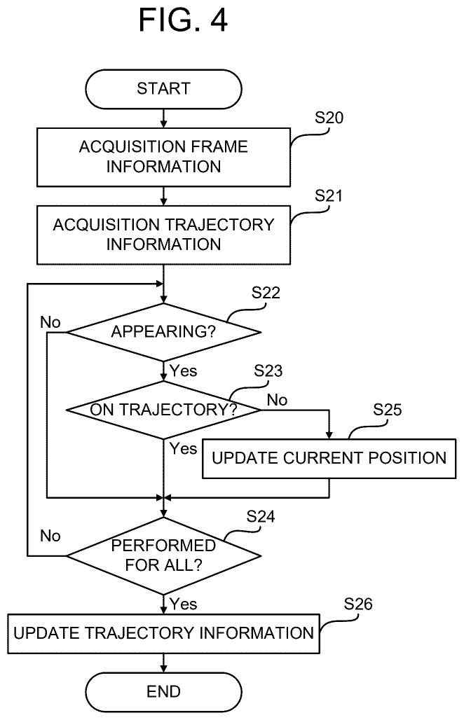

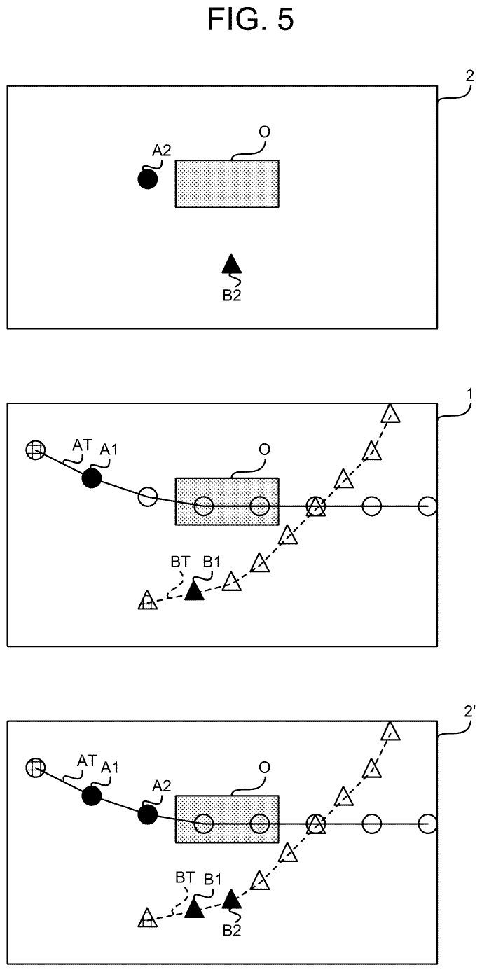

FIG. 4 shows a flowchart of the tracking operation performed by information processing apparatus 2. The operations from “start” to “end” shown in FIG. 4 may be frame-by-frame operations. FIG. 5 through FIG. 7 are conceptual diagrams of the tracking operation performed by the information processing apparatus 2.

As shown in FIG. 4, the acquiring unit 212 acquires frame information (step S20). The frame information includes information indicating the location of a person (or person-like object) as the target appearing in the corresponding frame of the video. The frame information may include information indicating a bounding box surrounding the person (or objects be tracked) that appears in the corresponding frame of the video. A frame 2 of FIG. 5 illustrates the frame 2 as a later frame acquired after frame 0. In the case illustrated in the frame 2 of FIG. 5, the frame information may include the position in the frame 2 of the person A, indicated by black circle A2, and the position in the frame 2 of the person B, indicated by black triangle B2.

The acquiring unit 212 acquires trajectory information (step S21). The trajectory information includes future positions of each of the persons to be tracked. The future positions are the estimated positions of the person to be tracked in the corresponding frame of the video and in subsequent frames after the corresponding frame. In addition to the future positions of each of the persons to be tracked, the trajectory information may also include past positions. The past position is the position of the person to be tracked in the previous frame of the video before the current frame. Furthermore, the trajectory information may include the initial position of each of the persons to be tracked. A frame 1 of FIG. 5 illustrates the trajectory information. The frame 1 of FIG. 5 illustrates a case in which the trajectory information includes the past position of the person A, indicated by a black circle, and the future position of the person A, indicated by a white circle, as well as the past position of the person B, indicated by a black triangle, and the future position of the person B, indicated by a white triangle. Black circle Al illustrates the position of the person A in frame 1 (an example of a frame acquired after the frame 0 and before the frame 2), and black triangle B1 illustrates the position of the person B in frame 1.

The appearance determination unit 2132 determines whether or not the person to be tracked appears in the corresponding frame (step S22). Referring to FIG. 5, the operation with respect to the frame 2 is explained. The frame 2 of FIG. 5 illustrates that the person A and the person B appear in the frame 2.

In case where the person to be tracked appears in the frame 2 (step S22: Yes), the stay/leave determination unit 2133 makes a determination based on the frame 2 and the trajectory information. The stay/leave determination unit 2133 determines whether or not the person to be tracked appearing in the frame 2 is on the trajectory (step S23). A frame 2′ of FIG. 5 illustrates that in the frame 2, the person A is at position A2 on the trajectory AT estimated based on frame 0. The stay/leave decision unit 2133 determines that the person A appearing in the frame 2 is on the trajectory AT. The tracking unit 213 tracks the person to be tracked by whether or not the target passes through the estimated trajectory.

In case where it is determined that the person to be tracked is on the trajectory estimated based on the previous frame (step S23: Yes), the process returns to step S22 to determine the next person to be tracked. The frame 2′ of FIG. 5 illustrates that in the frame 2, the person B is at position B2 on the trajectory BT estimated based on the frame 0. The stay/leave determination unit 2133 determines that the person B appearing in the frame 2 is on the trajectory BT.

The tracking unit 213 determines whether or not processing has been performed for all tracked persons appearing in the corresponding frame (step S24). In case where processing has been performed for all tracked persons appearing in the corresponding frame (step S24: Yes), the tracking unit 213 updates the trajectory information (step S26).

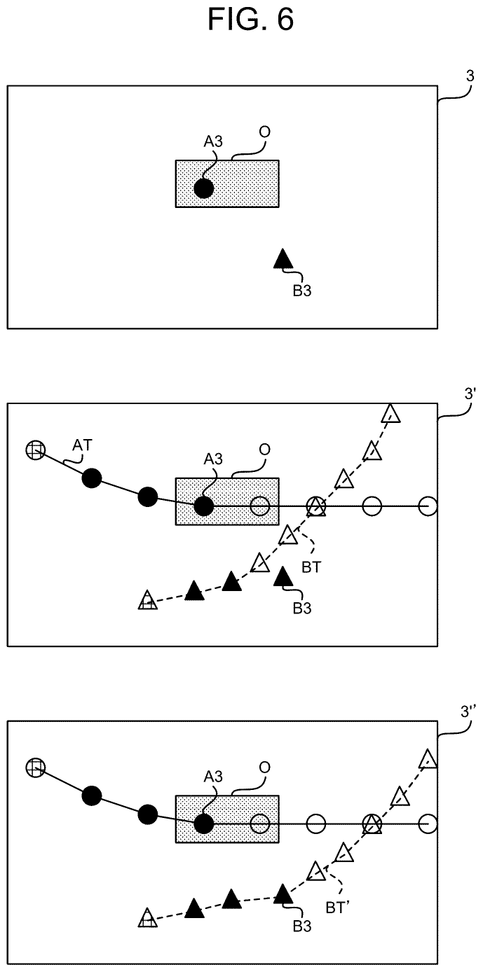

A frame 3 of FIG. 6 illustrates the frame 3, which is acquired later than the frame 2. Referring to FIG. 6, the operation regarding the frame 3 is explained. The frame 3 of FIG. 6 illustrates a case in which the person A does not appear in the frame 3 because the person A is hidden by the occlusion region O. The appearance determination unit 2132 may determine that the person to be tracked is hidden by the occlusion region O in case where the occlusion region O and the trajectory overlap. In case where the person to be tracked is not found within the predetermined range of the trajectory, the appearance determination unit 2132 may determine that the target is hidden in the occlusion region O. In case where the person to be tracked does not appear in the frame (step S22: No), the tracking unit 213 may estimate that the person to be tracked is on the trajectory. In other words, the tracking unit 213 may estimate that the person A is at position A3. The tracking unit 213 may determine that the case in which the person to be tracked, who should appear in the frame according to the estimated trajectory, does not appear in the frame, is a case in which the person is hidden by the occlusion region O. In other words, the tracking unit 213 may determine that the person is hidden by the occlusion region O.

A frame 3′ of FIG. 6 illustrates that although the person B appears in the frame 3 (step S22: Yes), it is not on the trajectory. In other words, the frame 3′ of FIG. 6 illustrates that the position B3 of the person B in the frame 3 is not on the trajectory BT estimated based on the frame prior to the frame 3. In case where the stay/leave determination unit 2133 determines that the person to be tracked is not on the trajectory estimated based on the previous frame (step S23: No), the tracking unit 213 updates the current position of the person to be tracked (step S25). In the case illustrated in a frame 3′ of FIG. 6, the tracking unit 213 updates the position of person B in the frame 3 included in the trajectory information to position B3.

In case where processing has been performed for all persons to be tracked that appear in frame 3 (step S24: Yes), the tracking unit 213 updates the trajectory information to include the past positions of the person A indicated by the black circles (the frame 1 through the frame 3) and future positions of the person A indicated by the white circles, and the past positions of the person B indicated by the black triangles (the frame 1 through the frame 3) and future positions of the person B indicated by the white triangles, as shown in the frame 3″ of FIG. 6 (step S26). In step S26, the trajectory estimation unit 2131 may update the trajectory based on the updated current position. For example, the trajectory estimation unit 2131 may update the trajectory BT illustrated in the frame 3′ of FIG. 6 to the trajectory BT′ illustrated in the frame 3″ of FIG. 6.

The operation of step S25 may be performed in step S26. Alternatively, the trajectory information may be updated for each target. In other words, the updating of trajectory information may be performed at timings other than those indicated by the flowchart in FIG. 4. The flow of operations shown in the flowchart of FIG. 4 may be understood as an example.

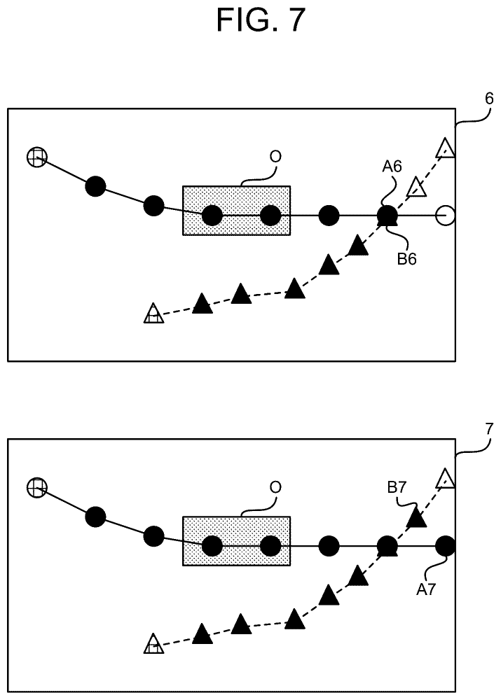

A frame 6 of FIG. 7 illustrates the frame 6, which is acquired later than the frame 3. The frame 6 of FIG. 7 illustrates that the person A and the person B are in the same position in the frame 6. The frame 6 of FIG. 7 can be rephrased as illustrating a case where one of the person A and the person B is hiding the other. In this case, the appearance determination unit 2132 may determine that only one of the person A and the person B appears in the frame 6. In other words, the appearance determination unit 2132 may determine that one of the person A and the person B hides the other in the frame 6 and that the other of the person A and the person B does not appear in the frame 6. In this case, the stay/leave determination unit 2133 may determine that one of the person A and the person B is stay/leave the trajectory. In this case, the appearance determination unit 2132 may determine that the other of the person A and the person B is on the trajectory.

A frame 7 of FIG. 7 illustrates the frame 7, which is acquired later than the frame 6. The tracking unit 213 tracks based on the trajectory estimated based on the previous frame, the result of the appearance determination by the appearance determination unit 2132, and the stay/leave determination by the stay/leave determination unit 2133. Therefore, the tracking unit 213 can find the person A at the position A7 on the trajectory AT in the frame 7. Also, the tracking unit 213 can find the person B at position B7 on the trajectory BT in the frame 7. In other words, the tracking unit 213 cannot mistake the person A for the person B even in case where the person A and the person B were at the same position in the previous frame. In this example embodiment, since the trajectories of each person to be tracked are independent, even in case where the trajectories of each person intersect, the persons to be tracked will not be interchanged.

### [2-3: Technical Effects of Information Processing Apparatus 2]

For example, in the case of the comparative example, where targets are tracked by comparing two targets that appear in two frames and assigning them to each other, the process becomes more complicated as the number of targets increases, and mistakes such as mistaking the target for the right person are more likely to occur. In addition, in the case of the comparative example, once a mistake is made in the mapping, the mistake may remain continuously afterwards. In other words, in the comparative example, the accuracy of tracking is often reduced.

In contrast, the information processing apparatus 2 of the second example embodiment estimates the trajectory, makes the stay/leave determination, and performs tracking based on the determination result of the stay/leave determination, so it is possible to suppress the possibility of mistaking the person to be tracked for the person to be tracked. Since the information processing apparatus 2 predicts the path of each target, it can track a plurality of targets simultaneously with high accuracy. Also, since the information processing apparatus 2 updates the trajectory based on the results of the stay/leave determination, it can track with high accuracy. In addition, since the information processing apparatus 2 detects new persons to be tracked that appear in the frame, each of the persons to be tracked that appear in the frame can be tracked with high accuracy.

In addition, since the information processing apparatus 2 performs appearance determination, it can handle cases where the person to be tracked is hidden in the occlusion area O. The occlusion area O is used to determine whether the person to be tracked is in the occlusion area O. Even in case where the person to be tracked does not appear in the frame due to the occlusion area O, the tracking can be continued and the tracking can be prevented from being interrupted. In other words, since the information processing apparatus 2 estimates the trajectory, it can perform robust tracking even in case where the target does not appear in the frame.

### 3: Third Example Embodiment

The third example embodiment of the information processing apparatus, information processing method, and recording medium will now be described. In the following, the third example embodiment of the information processing apparatus, information processing method, and recording medium will be described using information processing apparatus 3 to which the third example embodiment of the information processing apparatus, information processing method, and recording medium is applied.

### [3-1: Configuration of Information Processing Apparatus 3]

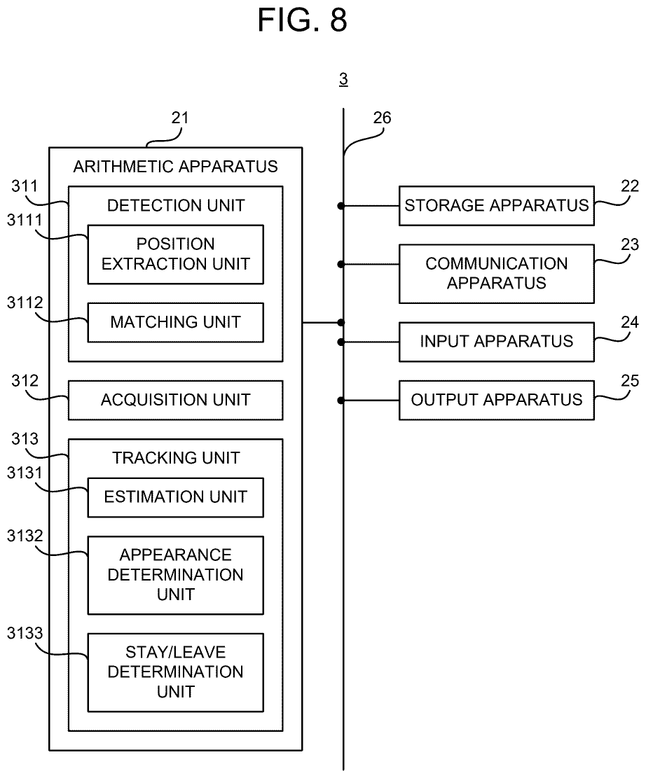

With reference to FIG. 8, the configuration of the information processing apparatus 3 in the third example embodiment will be described. FIG. 8 is a block diagram showing the configuration of information processing apparatus 3 in the third example embodiment.

As shown in FIG. 8, the information processing apparatus 3 in the third example embodiment is equipped with the arithmetic apparatus 21 and the storage apparatus 22, similar to the information processing apparatus 2 in the second example embodiment. Furthermore, the information processing apparatus 3 in the third example embodiment may be provided with the communication apparatus 23, the input apparatus 24, and the output apparatus 25, as in the information processing apparatus 2 in the second example embodiment. However, the information processing apparatus 3 may not be equipped with at least one of the communication apparatus 23, the input apparatus 24, and the output apparatus 25. The information processing apparatus 3 in the third example embodiment differs from the information processing apparatus 2 in the second example embodiment in that the detection unit 311 includes the position extraction unit 3111 and the matching unit 3112. Other features of the information processing apparatus 3 may be identical to other features of the information processing apparatus 2. For this reason, the following unit describes in detail the parts that differ from the already described example embodiments, and other overlapping parts shall be omitted from the description as appropriate.

### [3-2: Information Processing Operations Performed by Information Processing Apparatus 3]

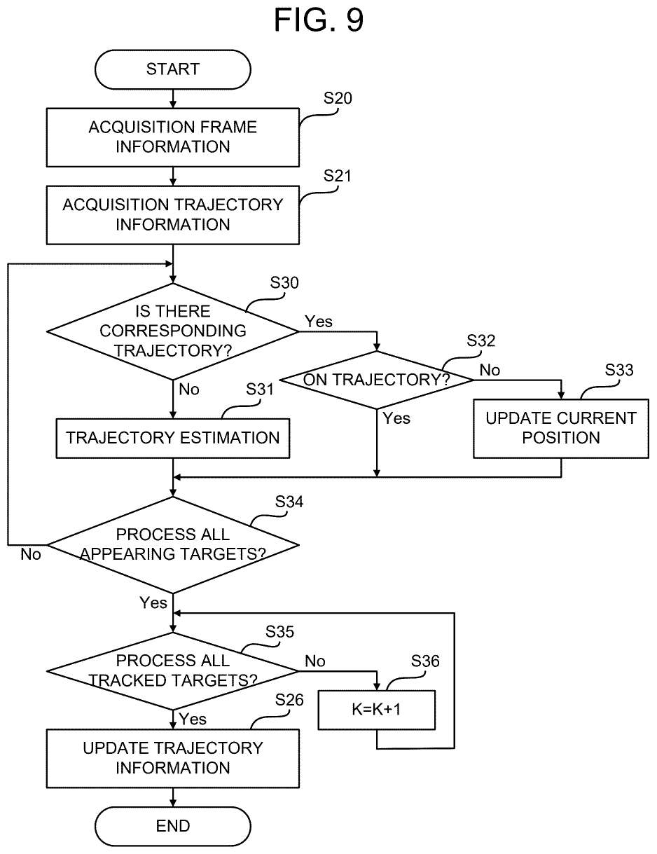

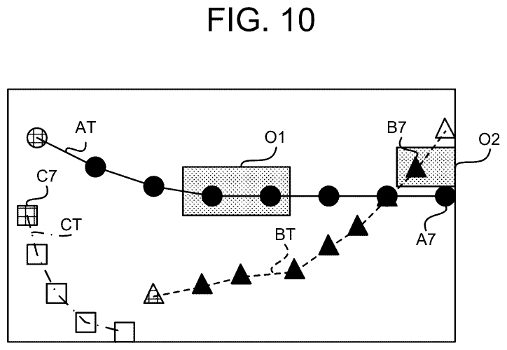

FIG. 9 is a flowchart showing the flow of information processing operations performed by the information processing apparatus 3. The operations from “start” to “end” shown in FIG. 9 may be frame-by-frame operations. FIG. 10 is a conceptual diagram of the information processing operations performed by the information processing apparatus 3.

### [3-2-1: Detection Operations Performed by the Detection Unit 311]

The position extraction unit 3111 outputs frame information in case where a frame is input. In case where a frame is input, the position extraction unit 3111 outputs information indicating the position of a person (or person-like object) appearing in the frame. The position extraction unit 3111 may output information indicating the bounding box surrounding the person (or person-like object) appearing in the frame.

As shown in FIG. 9, in the third example embodiment, in step S20, the frame information output by the position extraction unit 3111 is acquired. FIG. 10 illustrates the frame 7, which is acquired later than the frame 6 illustrated in FIG. 7. In the case illustrated in FIG. 10, the frame information may include the position in the frame 7 of the person indicated by the black circle A7 and the position in the frame 7 of the person indicated by the square C7 of the lattice pattern.

In other words, FIG. 10 illustrates the case where the person B is hidden in occlusion area O2 in the frame 7. FIG. 10 also illustrates the appearance of a person to be tracked in the frame 7 that does not correspond to either trajectory AT or trajectory BT. The following is an explanation of the operation regarding the frame 7 with reference to FIG. 10.

The acquisition unit 312 acquires trajectory information (step S21). The trajectory information may include, for example, information on the positions of the person A and the person B from the frame 0 to the frame 6, as illustrated in FIG. 7, and the estimated positions after the frame 7.

The matching unit 3112 determines whether there is a trajectory corresponding to the person included in the frame information based on the position of the person included in the frame information and the position of the person to be tracked included in the trajectory information (step S30). The matching unit 3112 may determine whether the frame information includes a new person to be tracked according to the overlap rate between the bounding box included in the frame information and the bounding box included in the trajectory information. In other words, the matching unit 3112 may determine whether the person included in the frame information and the person to be tracked included in the trajectory information are the same person according to whether the position of the person included in the frame information and the position of the person to be tracked included in the trajectory information are closer than specified. The operations from step S30 to step S34 are for each person appearing in the frame.

The matching unit 3112 makes a determination about the person indicated by square C7 of the lattice pattern. The location of the person indicated by square C7 of the lattice pattern does not correspond to either the trajectory AT or the trajectory BT. In case where there is no corresponding trajectory (step S30: No), the matching unit 3112 determines that the person indicated by square C7 of the lattice pattern is a new person to be tracked, and the trajectory estimation unit 3131 estimates the trajectory of the new person to be tracked (step S31). In other words, the detection unit 311 detects the new person to be tracked based on the trajectory estimated based on frames prior to the frame 7. In this case, the frame prior to the frame 7 is an example of a “third frame” as described in the Supplemental Note below.

### [3-2-2: Tracking Operation Performed by Tracking Unit 313]

The matching unit 3112 next determines the person indicated by black circle A7. Since the location of the person indicated by black circle A7 corresponds to the trajectory AT (step S30: Yes), the matching unit 3112 determines that the person indicated by black circle A7 is not a new person to be tracked, and the tracking unit 313 determines that the person indicated by black circle A7 is person A to be tracked.

The stay/leave determination unit 3133 determines whether or not the person A to be tracked who appears in the frame 7 is on the trajectory AT (step S32). The stay/leave determination unit 3133 may be rephrased as determining whether or not the position of the person indicated by the black circle A7 is on the trajectory AT.

In the frame 7, the person A to be tracked is on the trajectory AT (step S32: Yes), so the tracking unit 313 does not update the current position. On the other hand, in case where the person A to be tracked is not on the trajectory AT (step S32: No), the tracking unit 313 updates the current position (step S33) in the same way as in step S25 described above. In other words, in case where the person to be tracked was on the trajectory, the tracking unit 313 tracks the person according to the trajectory.

Furthermore, the stay/leave determination unit 3133 may make a comparative determination between a group of detected positions (bounding boxes) included in the trajectory and the bounding boxes detected by the detection unit 311 in a specific frame. The stay/leave determination unit 3133 may determine that the detected bounding boxes are the same person in case where they are in the vicinity of the trajectory. In case where the detected bounding box is not in the vicinity of the trajectory, the stay/leave decision unit 3133 may determine that it is a different person. In case where the stay/leave decision unit 3133 determines that they are the same person, the tracking unit 313 may merge the corresponding trajectories together.

The matching unit 3112 determines whether or not processing has been performed for all persons appearing in the frame (step S34). Since the fact that the person is target to the operation from step S30 to step S34 means that the person has been detected as a person appearing in the frame by the position extraction unit 3111, the tracking unit 3113 resets “K” of the person to be tracked that is target to the operation from step S30 to step S34 to “0”. The “K” of the person to be tracked may be reset to “0”.

In case where processing has been performed for all persons appearing in the frame (step S34: Yes), the tracking unit 313 determines whether the tracking operation has been performed for all persons to be tracked in the trajectory information (step S35). In the case illustrated in FIG. 10, the position B7 is hidden by the occlusion area O2, and the position extraction unit 3111 has not detected the person indicated by black triangle B7. Therefore, the tracking unit 313 has not performed any tracking operation on the person B to be tracked in the tracking information.

For the person B to be tracked for whom no tracking operation has been performed, i.e., who has not appeared in the frame, the appearance determination unit 3132 adds 1 to “K” (step S36). The “K” is a variable representing the number of times the person to be tracked does not appear in the frame consecutively. In case where the “K” of the person to be tracked exceeds the upper limit, the tracking unit 313 may determine that the person to be tracked is not to be tracked and terminate the tracking of the person to be tracked. The upper limit of “K” may be set based on the estimated time until the person to be tracked moves out of the frame. In other words, in case where “K” exceeds the upper limit, the tracking unit 313 may assume that the person to be tracked has moved out of the frame. In the frame 7, the appearance determination unit 3132 considers the person B to be at the position B7 on the trajectory BT. The process from step S35 to step S36 is for each of the tracking targets included in the tracking information.

The flow of a series of information processing operations shown in the flowchart in FIG. 9 is an example. The order of each of the above-mentioned processes, such as the stay/leave determination operation, appearance determination operation, etc., may be interchanged. The information processing apparatus 3 may also execute any of the processes in parallel. The information processing apparatus 3 should perform each of the abovementioned operations from the time a frame is input to the time it outputs the updated trajectory information.

In case where tracking operations have been performed for all the persons to be tracked included in the trajectory information (step S35: Yes), the tracking unit 313 updates the trajectory information (step S26). In step S26, the tracking unit 313 may exclude from the tracking target persons for whom “K” exceeds the upper limit. The tracking unit 313 may also exclude from the tracking target persons whose estimated future location does not appear in the frame. For example, in the case illustrated in FIG. 10, the frame does not contain the future location of the person A to be tracked (i.e., the white circle). In this case, the tracking unit 313 may exclude the person A to be tracked from the tracking target.

### [3-3: Tracking Network TN]

The information processing unit 3 may realize information processing operations using a tracking network TN. The tracking network TN may be a mechanism constructed based on deep learning.

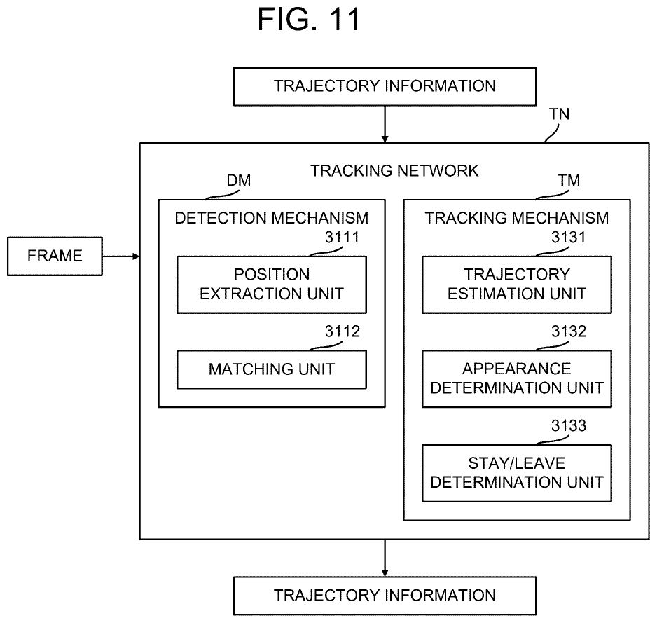

FIG. 11 is a block diagram of the tracking network TN. As shown in FIG. 11, the tracking network TN is a mechanism that outputs trajectory information in case where a frame is input. The tracking network TN also receives the trajectory information output in response to the previous frame. The tracking network TN includes a detection mechanism DM and a tracking mechanism TM.

The detection mechanism DM is a network that detects new persons to be tracked that appear in the video. The detection mechanism DM may include a mechanism such as a fundamental network that extracts features from images, a detection mechanism that detects targets using the features, and a selection mechanism that selects new persons to be tracked from the detection results. The detection mechanism DM may be a mechanism using a convolutional neural network. The detection unit 311 may use the detection mechanism DM to realize the detection operation.

The tracking mechanism TM is a module that tracks the person to be tracked. The tracking mechanism TM may include a mechanism that extracts features from time series information. The tracking mechanism TM may include a mechanism using RNN employing LSTM. The tracking unit 313 may realize tracking operations using the tracking mechanism TM. The tracking mechanism TM can handle relatively long time information by employing LSTM. The tracking mechanism TM may, for example, estimate the trajectory from 100 to 500 frames ahead. The tracking mechanism TM employing LSTM has a loop function, so that the state of processing the frame in question can be carried over to the state of processing subsequent frames. This allows the tracking mechanism TM to handle time-series information. The quantity that indicates the characteristics of the state of the tracking network TN in case where it processes a frame is called the internal features.

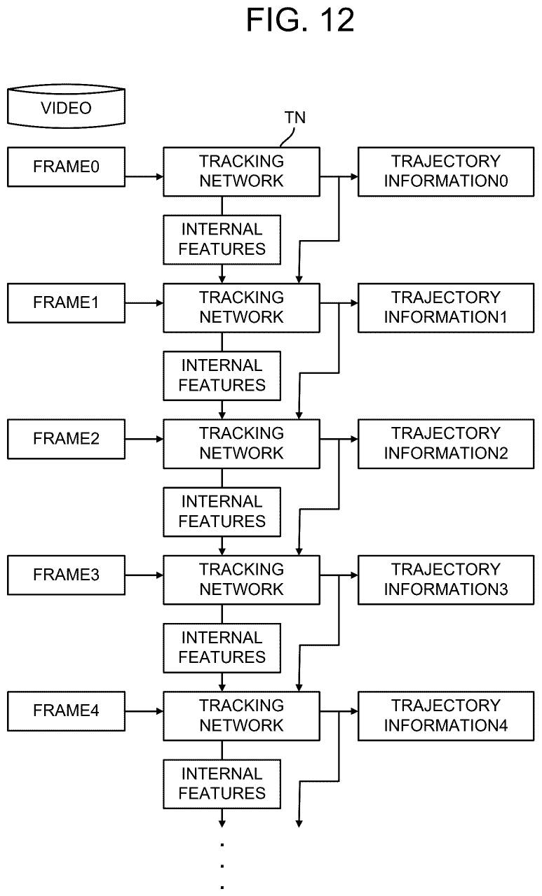

FIG. 12 is a conceptual diagram of the information processing operation realized by the tracking network TN. In case where the frame 0 is input, the tracking network TN outputs the trajectory information 0. The tracking network TN also outputs internal features. The trajectory information 0 and the internal features are input to the tracking network TN along with the frame 1. In other words, the tracking network TN uses the output from the operation prior to the operation in which the corresponding frame is input as information about the operation in which the corresponding frame is input. This allows the tracking network TN to reflect the influence of information input in the past during the operation in which the relevant frame is input. In case where the frame 1, the trajectory information 0, and the internal features are input, the tracking network TN outputs trajectory information 1. Trajectory information 1 may be understood to be an updated version of the trajectory information 0.

Similarly, in case where the frame 2, the trajectory information 1, and the internal features are input, the tracking network TN outputs trajectory information 2. In case where the frame 3, the trajectory information 2, and the internal features are input, the tracking network TN outputs trajectory information 3. The tracking network TN repeats the same operation.

### [3-4: Technical Effects of Information Processing Apparatus 3]

The information processing apparatus 3 for the third example embodiment uses the detection mechanism of the first stage only for the operation of detecting the newly appeared tracking target. The information processing apparatus 3 also performs the tracking operation of the detected tracking target using only the tracking mechanism in the latter stage. In other words, since the information processing apparatus 3 is designed to execute the tracking operation without relying on the detection mechanism, it can suppress tracking interruptions even in case where the detection mechanism cannot take time series into account. In addition, since information processing apparatus 3 estimates the trajectory of the person to be tracked using a mechanism that extracts features from time series information, it can estimate the trajectory over a relatively long period of time. The information processing apparatus 3 is able to deal with relatively long tracking interruptions, such as occlusion, in case where they occur. Since the information processing apparatus 3 can continue tracking to the end point of the estimated trajectory, it can track long distances. On the other hand, the information processing apparatus 3 can suppress unnecessary processing because it can exclude from tracking a person to be tracked who has moved out of the frame. In addition, since the information processing apparatus 3 excludes from tracking persons who do not appear in the frame for a long period of time, it is possible to suppress unnecessary processing.

The information processing apparatus 3 according to this example embodiment can be applied to all applications that implement multi-object tracking. For example, the information processing apparatus 3 can be applied to gateless authentication systems, crime prevention systems, systems that use motion recognition, systems that track specific objects, and the like. Systems that use motion recognition can include business monitoring systems, expert behavior analysis systems, and the like. Specific objects can include people, faces, hands, cars, tools, foreign targets, etc.

### 4: Supplemental Note

The following additional notes are further disclosed with respect to the example embodiments described above.

### [Supplemental Note 1]

An information processing apparatus comprising:
an estimation means for estimating a trajectory of a target appearing in a first frame of a video;
an appearance determination means for performing an appearance determination to determine whether or not the target appears in a second frame different from the first frame; and
a stay/leave determination means for performing a stay/leave determination to determine whether or not the target appearing in the second frame is on the trajectory.

### [Supplemental Note 2]

The information processing apparatus according to Supplemental Note 1, further comprising:
a detection means for detecting the target whose trajectory is estimated by the estimation means from the first frame.

### [Supplemental Note 3]

The information processing apparatus according to Supplemental Note 1 or 2, wherein
the estimation means updates the trajectory based on at least one of the result of the stay/leave determination by the stay/leave determination means and the result of the appearance determination by the appearance determination means.

### [Supplemental Note 4]

The information processing apparatus according to Supplemental Note 1 or 2, further comprising a tracking means for tracking the target based on the trajectory, the result of the stay/leave determination by the stay/leave determination means, and the result of the appearance determination by the appearance determination means.

### [Supplemental Note 5]

The information processing apparatus according to Supplemental Note 2, wherein
the detection means detects the target using the trajectory estimated based on a third frame different from the first frame.

### [Supplemental Note 6]

The information processing apparatus according to Supplemental Note 4, wherein
the tracking means tracks the target using a mechanism for extracting features from time-series information.

### [Supplemental Note 7]

The information processing apparatus according to Supplemental Note 4, wherein
the estimation means estimates the trajectory of the target within frames of the video, and
the tracking means tracks the target within the frames of the video.

### [Supplemental Note 8]

The information processing apparatus according to Claim 4, wherein
in case where the appearance determination means determines that the target has not appeared over a predetermined number of frames or more, the tracking means ends the tracking of the target.

### [Supplemental Note 9]

An information processing method comprising:
estimating a trajectory of a target appearing in a first frame of a video;
performing an appearance determination to determine whether or not the target appears in a second frame different from the first frame; and
performing a stay/leave determination to determine whether or not the target appearing in the second frame is on the trajectory.

### [Supplemental Note 10]

A recording medium on which a computer program is stored, the computer program being configured to allow a computer to execute an information processing method comprising:
estimating a trajectory of a target appearing in a first frame of a video;
performing an appearance determination to determine whether or not the target appears in a second frame different from the first frame; and
performing a stay/leave determination to determine whether or not the target appearing in the second frame is on the trajectory.

This disclosure can be changed as appropriate to the extent that it does not contradict this technical concept that can be read from the claims and the specification as a whole. The information processing apparatus, information processing method, and recording medium with such changes are also included in the technical concept of this disclosure.

### DESCRIPTION OF REFERENCE CODES

1, 2, 3 Information processing apparatus
11 Estimation unit
12, 2132, 3132 Appearance determination unit
13, 2133, 3133 Stay/leave determination unit
211, 311 Detection unit
3111 Position extraction unit
3112 Matching unit
212, 312 Acquisition unit
213, 313 Tracking unit
2131, 3131 Trajectory estimation unit
TN Tracking network
DM Detection mechanism
TM Tracking mechanism

What is claimed is:

1. An information processing apparatus comprising:
at least one memory storing instructions; and
at least one processor that is configured to execute the instructions for:
estimating a trajectory of a target appearing in a first frame of a video;
performing an appearance determination to determine whether or not the target appears in a second frame different from the first frame; and
performing a stay/leave determination to determine whether or not the target appearing in the second frame is on the trajectory.

2. The information processing apparatus according to claim 1,
wherein the at least one processor that is configured to execute the instructions for detecting the target whose trajectory is estimated from the first frame.

3. The information processing apparatus according to claim 1, wherein
the at least one processor that is configured to execute the instructions for updating the trajectory based on at least one of the result of the stay/leave determination and the result of the appearance determination.

4. The information processing apparatus according to claim 1,
wherein the at least one processor that is configured to execute the instructions for tracking the target based on the trajectory, the result of the stay/leave determination, and the result of the appearance determination.

5. The information processing apparatus according to claim 2, wherein
the at least one processor that is configured to execute the instructions for detecting the target using the trajectory estimated based on a third frame different from the first frame.

6. The information processing apparatus according to claim 4, wherein
the at least one processor that is configured to execute the instructions for tracking the target using a mechanism for extracting features from time-series information.

7. The information processing apparatus according to claim 4, wherein the at least one processor that is configured to execute the instructions for:
estimating the trajectory of the target within frames of the video; and
tracking the target within the frames of the video.

8. The information processing apparatus according to claim 4, wherein
in case where the target has not appeared over a predetermined number of frames or more, the at least one processor that is configured to execute the instructions for ending the tracking of the target.

9. An information processing method comprising:
estimating a trajectory of a target appearing in a first frame of a video;
performing an appearance determination to determine whether or not the target appears in a second frame different from the first frame; and
performing a stay/leave determination to determine whether or not the target appearing in the second frame is on the trajectory.

10. A non-transitory recording medium on which a computer program is stored, the computer program being configured to allow a computer to execute an information processing method comprising:
estimating a trajectory of a target appearing in a first frame of a video;
performing an appearance determination to determine whether or not the target appears in a second frame different from the first frame; and
performing a stay/leave determination to determine whether or not the target appearing in the second frame is on the trajectory.
